(19) United States
(12) Patent Application Publication
(10) Pub. No.: US 2011/0091710 A1
(43) Pub. Date: Apr. 21, 2011

(54) SOFT FIBER INSULATION PRODUCT

(76) Inventors: David R. Mirth, Reynoldsburg, OH (US); William M. Babbitt, New Albany, OH (US); Liang Chen, New Albany, OH (US); Jesus M. Hernandez-Torres, Pataskala, OH (US)

(21) Appl. No.: 12/758,910

(22) Filed: Apr. 13, 2010

Related U.S. Application Data
(60) Provisional application No. 61/168,643, filed on Apr. 13, 2009.

(51) Int. Cl. D04H 1/64; B32B 5/02; C03B 37/01; C03B 37/10; C03C 25/42; E04B 1/74

(52) U.S. Cl. 428/297.4; 428/292.1; 65/442; 252/62

(57) ABSTRACT

A rotary fibrous insulation product that is soft to the touch is provided. The fibrous insulation product is formed of glass fibers having an average fiber diameter less than about 5.5 microns. The low fiber diameter helps to impart a soft feel to the insulation product. Additionally, the insulation product contains an oil with a flashpoint of at least 580° F. in an amount up to 5% by weight of the insulation product. The insulation product may contain up to about 85% by weight recycled glass. In exemplary embodiments, the binder is a low-formaldehyde, polyacrylic based binder. The combination of the low fiber diameter, the binder, and the oil create a synergistic effect to produce an unexpectedly soft insulation product. The insulation product is useful in a variety of thermal applications, such as in basements, in attics, and in walls of residential dwellings.

### CROSS-REFERENCE TO RELATED APPLICATIONS

This application is related to and claims domestic priority benefits from U.S. Provisional Patent Application Ser. No. 61/168,643 entitled “Soft Fiber Insulation Product” filed Apr. 13, 2009, the entire content of which is expressly incorporated herein by reference in its entirety.

### TECHNICAL FIELD AND INDUSTRIAL APPLICABILITY OF THE INVENTION

The present invention relates generally to rotary fiber insulation, and more particularly, to a fiberglass insulation product that is soft to the touch.

### BACKGROUND OF THE INVENTION

Fiber insulation is typically formed of mineral fibers (e.g., glass fibers) and/or organic fibers (e.g., polypropylene fibers), bound together by a binder material. The binder material gives the insulation product resiliency for recovery after packaging and provides stiffness and handleability so that the insulation product can be handled and applied as needed in insulation cavities of buildings. During manufacturing, the fiber insulation is cut into lengths to form individual insulation products, and the insulation products are packaged for shipping to customer locations. One typical insulation product is an insulation batt, which is suitable for use as wall insulation in residential dwellings or as insulation in the attic and floor insulation cavities in buildings.

Faced insulation products are installed with the facing placed flat on the edge of the insulation cavity, typically on the interior side of the insulation cavity. Insulation products where the facing is a vapor retarder are commonly used to insulate wall, floor, or ceiling cavities that separate a warm interior space from a cold exterior space. The vapor retarder is placed on one side of the insulation product to retard or prohibit the movement of water vapor through the insulation product.

Placing the insulation products into the cavities requires a great deal of contact by the worker installing the insulation. For instance, the insulation product needs to be transferred to the cavity within the house and then pressed into the cavity by the worker. Conventional insulation products are rough and generally uncomfortable to the touch. In addition, fibers from the insulation may break free from the insulation batt and provide an inhalation irritant to the worker, thus requiring the worker to wear protective masks. The loose fibers, as well as the bound fibers in the insulation product, can be a skin irritant. Accordingly, the release of loose fibers into the air is undesirable, particularly in enclosed spaces, because the fibers may be inhaled by the workers, or may come into contact with a part of the body, if they are not properly protected.

Accordingly, there exists a need in the art for a fibrous insulation product that is soft to the touch, reduces the occurrence of loose fibers, reduces the need for protective equipment, and is inexpensive to manufacture.

### SUMMARY OF THE INVENTION

It is an object of the present invention to provide a soft fibrous insulation product that includes a plurality of fibers with an average fiber diameter less than about 5.5 microns and a binder composition that may include an oil in an amount of at least 0.5% by weight of the insulation product. In exemplary embodiments, the fibers may have an average fiber diameter from about 2.5 microns to about 5.5 microns. In addition, the soft insulation product may contain up to about 85% by weight recycled glass. In exemplary embodiments, the binder is a polyacrylic-based binder. The insulation product may have a facing material on one of the major surfaces. The inventive insulation product is unexpectedly soft to the touch and is softer than conventional fiberglass insulation products.

It is another object of the present invention to provide a soft glass fiber having a fiber diameter less than about 5.5 microns at least partially coated with a binder composition containing an oil. In exemplary embodiments, the oil is a mineral oil and the binder is a polyacrylic acid-based binder.

It is yet another object of the present invention to provide a method of manufacturing a soft fiberglass insulation product that includes fiberizing molten glass to form individual glass fibers having an average fiber diameter less than about 5.5 microns, applying a binder composition including an oil in an amount of at least 0.5% by weight of the insulation product to at least a portion of the glass fibers, collecting the binder coated glass fibers on a conveying apparatus to form a fibrous pack, and heating the fibrous pack to dry the glass fibers and at least partially cure the binder. The oil may be present in the insulation product in an amount from about 0.2 to about 5.0% by weight of the insulation product. In exemplary embodiments, the binder is a polyacrylic acid-based binder and the fibers have an average fiber diameter from about 2.5 to about 5.5 microns. Additionally, the insulation product may include up to about 85% recycled glass, or even 100% recycled glass.

It is an advantage of the present invention that the inventive insulation products have a softer feel compared to conventional fiberglass insulation products.

It is also an advantage of the present invention that the insulation product has a reduced occurrence of loose glass fibers.

It is yet another advantage of the present invention that the combination of the small fiber diameter of the glass fibers and the binder formulation which contains an oil have a synergistic affect to form an insulation product with an unexpectedly soft hand.

It is a feature of the present invention that the insulation product contains up to 5.0% by weight oil based on the total insulation product.

It is a feature of the present invention that the glass fibers forming the insulation product have a small fiber diameter of less than approximately 5.5 microns.

It is yet another feature of the present invention that the insulation product may contain 100% recycled glass.

It is also a feature of the present invention that insulation products made in accordance with the present invention can be manufactured using current manufacturing lines, thereby saving time and money.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a manufacturing line for producing a faced fibrous insulation product in which the faced insulation product is rolled by a roll-up device according on an exemplary embodiment of the present invention;

FIG. 1A is a perspective view, partially cut away, of a faced insulation product having a facing material on one major surface thereof according to at least one embodiment of the present invention;

FIG. 2 is a schematic illustration similar to that of FIG. 1, but showing an alternate embodiment of the manufacturing line of FIG. 1 where the faced insulation product is cut into panels according to another exemplary embodiment of the present invention;

FIG. 3 is a schematic illustration depicting an alternate embodiment of the manufacturing line of FIG. 1 in which the faced insulation product is bisected and rolled into two separate rolls by roll-up devices;

FIG. 3A is a schematic illustration depicting an alternate embodiment of the manufacturing line of FIG. 3 in which only one facer is attached to the fibrous pack;

FIG. 4 is an elevational view of a manufacturing line for producing a fiberglass insulation product that does not contain a facing material according to at least one exemplary embodiment of the present invention; and

FIG. 5 is a graphical analysis of the individual 95% statistical confidence intervals for the mean based on standard deviation.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “top”, “bottom”, “side”, “upper”, “lower” and the like are used herein for the purpose of explanation only. It will be understood that when an element is referred to as being “on,” another element, it can be directly on or against the other element or intervening elements may be present. It is to be noted that the phrase “binder composition” and “binder” may be used interchangeably herein. “Fibrous insulation product”, “insulation product”, “fibrous insulation”, and “faced insulation product” may also interchangeably used in this application.

The present invention relates to a rotary fibrous insulation product that is soft to the touch. The fibrous insulation product contains at least 0.5% by weight oil based on the total fiber insulation product and glass fibers having a diameter of less than about 5.5 microns. The low fiber diameter helps to impart a soft feel to the insulation product. Additionally, the insulation product may contain up to about 85% by weight recycled glass. The insulation product is useful in a variety of thermal applications, such as in basements, in attics, and in walls of residential dwellings.

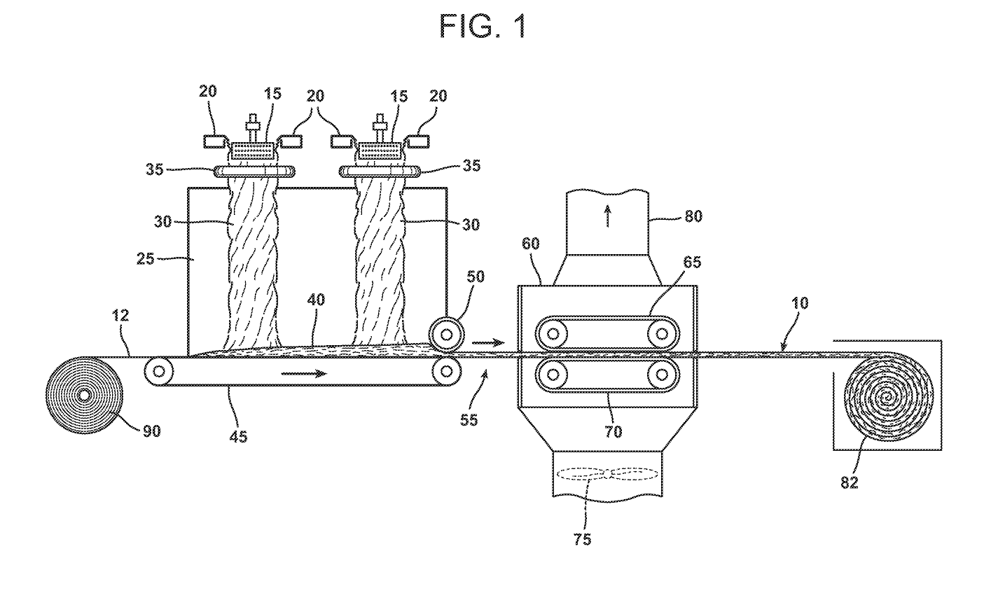

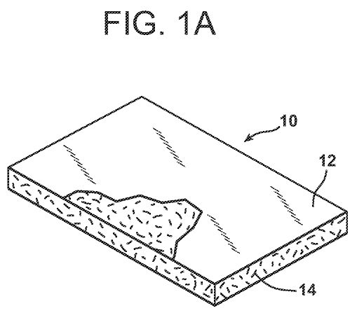

The manufacture of the insulation product may be carried out by a continuous process by fiberizing molten glass and forming a fibrous glass batt on a moving conveyor. Turning to FIG. 1, glass may be melted in a tank (not shown) and supplied to a fiber forming device such as a fiberizing spinner 15 rotating at high speeds. Centrifugal force causes the molten glass to pass through the holes in the circumferential sidewalls of the fiberizing spinners 15 to form glass fibers. Single component glass fibers of random lengths may be attenuated from the fiberizing spinners 15 and blown generally downwardly, that is, generally perpendicular to the plane of the spinners 15, by blowers 20 positioned within a forming chamber 25. The blowers 20 turn the fibers downward to form a veil or curtain 30.

Suitable fibers used to form the insulation product include any type of glass fiber, including, but not limited to A-type glass fibers, C-type glass fibers, E-type glass fibers, S-type glass fibers, ECR-type glass (e.g., Owens Corning's Advantex® glass fibers), and modifications thereof. Further examples of glass fibers that may be used in the present invention are described in U.S. Pat. No. 6,527,014 to Aubourg; U.S. Pat. No. 5,932,499 to Xu et al.; U.S. Pat. No. 5,523,264 to Mattison; and U.S. Pat. No. 5,055,428 to Porter, the contents of which are expressly incorporated by reference in their entirety. Optionally, other reinforcing fibers such as natural fibers, mineral fibers, carbon fibers, ceramic fibers, and/or synthetic fibers such as polyester, polyethylene, polyethylene terephthalate, polypropylene, polyamide, aramid, and/or polyaramid fibers may be present in the insulation product in addition to the glass fibers. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include basalt, cotton, jute, bamboo, ramie, bagasse, hemp, coir, linen, kenaf, sisal, flax, henequen, and combinations thereof.

Fiber diameter is typically measured in microns (μm). In the present invention, the fiber diameters were measured with a propriety device and the diameters of the glass fibers were calculated according to Formula I:

$${d}_{E 0} = \frac{{\overline{d}}^{2} + {σ}^{2}}{\overline{d}} \qquad Formula I$$

where d̅ and σ are the mean and standard deviation of the fiber diameter distribution, respectively, measured under a microscope. The measurements calculated in terms of HT are then converted and/or calculated to microns.

The glass fibers in the inventive insulation product have an average fiber diameter of less than about 5.5 microns (i.e., about 21 HT). In exemplary embodiments, the glass fibers may have an average fiber diameter from about 2.5 to about 5.0 microns (i.e., about 10 to about 20 HT), preferably from about 3.5 to about 5.0 microns (i.e., about 14 to about 20 HT), and even more preferably from about 3.5 to about 4.5 microns (i.e., about 14 to about 18 HT). The small diameter of the glass fibers helps give the final insulation product a soft feel and flexibility.

In addition, the insulation product may be formed of 100% recycled glass. In an exemplary embodiment, the fiber insulation product may contain recycled glass in an amount up to about 50% by weight of the fibrous insulation product. In other exemplary embodiments, the fiber insulation product may contain recycled glass in an amount up to about 60% or about 70% by weight of the fibrous insulation product. In yet another exemplary embodiment, the fiber insulation product may contain recycled glass in an amount up to about 85% by weight of the fibrous insulation product. An increased content of recycled glass provides an insulation product that is more environmentally friendly. It is to be appreciated that recycled and non-recycled glass works equally well as fibers in the insulation product.

The glass fibers, while in transit in the forming chamber 25 and while still hot from the drawing operation, are sprayed with an aqueous binder composition by an annular spray ring 35 so as to result in a distribution of the binder composition throughout the formed insulation pack 40. Water may also be applied to the glass fibers in the forming chamber 25 (not illustrated), such as by spraying, prior to the application of the binder composition to at least partially cool the glass fibers.

The binder utilized may be a polycarboxylic acid based binder such as a polyacrylic acid glycerol (PAG) binder or a polyacrylic acid triethanolamine (PAT) binder. Such binders are known for use in connection with rotary fiberglass insulation. Examples of such binder technology are found in U.S. Pat. Nos. 5,318,990 to Straus; 5,340,868 to Straus et al.; 5,661,213 to Arkens et al.; 6,274,661 to Chen et al.; 6,699,945 to Chen et al.; and 6,884,849 to Chen et al., each of which is expressly incorporated entirely by reference. Conventional binders such as, but not limited to, phenol-formaldehyde binders and urea-formaldehyde binders may also be suitable for use in the present invention. It is also envisioned that a bio-based binder, a carbohydrate-based binder (e.g., starch- and/or sugar-based binder), a protein-based binder (e.g., soy-based binder), a vegetable oil-based binder, a plant oil-based binder, a urethane-based binder, and/or a furan-based binder may be suitable for use in the present invention. Preferably, the binder is a low-formaldehyde, polyacrylic acid-based binder. The binder may be present in the insulation product in an amount from about 1% to about 12% by weight of the insulation product, and in exemplary embodiments, from about 1% to about 10% by weight of the insulation product, from about 2% to about 8% by weight of the insulation product, from about 2% to about 6% by weight of the insulation product, or from about 3% to about 6% by weight of the insulation product or from about 4% to about 5% by weight of the insulation product. Unless defined otherwise, the phrase “% by weight” as used herein is meant to denote “% by weight of the insulation product”.

An oil is added to the binder such that the oil is sprayed onto the glass fibers with the binder (i.e., either as a part of the binder or sprayed at the same time as the binder) during the fiber forming process as described in detail above. It is also considered to be within the purview of the invention to apply the oil after the formation of the fibers (e.g., separate from the binder), prior to the fiber pack entering the oven, or after the fiber pack exits the oven. The oil should be heavy enough to survive the curing process for the binder. Specifically, the oil may have a flashpoint 580° F. or greater. The oil is added to the binder in an amount up to about 5% by weight of the fibrous insulation product. In exemplary embodiments, the oil is present in the insulation product in an amount greater than 0.5% by weight of the insulation product, or greater than 0.75% by weight of the insulation product. The oil may be present in the insulation product in an amount from about 0.2 to about 5.0% by weight of the insulation product, from about 0.2 to about 3.0% by weight of the insulation product, from about 0.5 to about 2.0% by weight, from about 0.75 to about 2.0% by weight, or from about 0.5 to about 1.5% by weight. In exemplary embodiments, the oil is present in an amount of about 1.0% by weight of the insulation product, or from about 0.5 to about 1.0% by weight. In one or more exemplary embodiment, the oil is present in an amount from 0.5 to about 0.75% by weight of the insulation product.

The oil may be a mineral oil, a synthetic oil, a silicone oil, and/or a plant oil. Non-limiting examples of suitable oils for use in the present invention include vegetable oil, cottonseed oil, soy bean oil, corn oil, and modification or blends thereof. The presence of the oil reduces the occurrence of loose glass fibers, thereby reducing potential irritation to workers handling and/or installing the fibrous insulation product. Although not wishing to be bound by any particular theory, it is believed that the oil, in combination with the binder and the low fiber diameter of the glass fibers, have a synergistic effect which creates a fiber insulation product that is softer to the touch than conventional insulation products. It is to be appreciated that although reference is made herein to a soft fibrous insulation product, individual glass fibers with a small fiber diameter having thereon a binder and oil also have an unexpectedly soft touch.

The oil may be present in the form of an emulsion containing one or more surfactant and/or dispersant. The oil emulsion or dispersion may be made with a surfactant and/or a dispersant so that the emulsion can be miscible and compatible with the basic resin premix solution without phase separation. The surfactant and/or dispersant serve to improve binder and oil wetting on the glass fibers. The surfactant and/or dispersant may be present in the insulation product in an amount from about 2.0 to about 20% by weight of the oil emulsion, from about 5% to about 15% by weight of the oil emulsion, from about 5% to about 10% by weight of the oil emulsion, or from about 5% to about 8% by weight of the oil emulsion.

Suitable surfactants that may be utilized in the oil emulsion include surfactants selected from cationic surfactants, amphoteric surfactants, nonionic surfactants, and mixtures thereof. Non-limiting examples of useful cationic surfactants include alkylamine salts such as laurylamine acetate, quaternary ammonium salts such as lauryl trimethyl ammonium chloride and alkyl benzyl dimethylammonium chlorides, and polyoxyethylenealkylamines. Suitable examples of amphoteric surfactants include alkylbetaines such as lauryl-betaine. Examples of nonionic surfactants which for use in conjunction with the present invention include, but are not limited to, polyethers (e.g., ethylene oxide and propylene oxide condensates which include straight and branched chain alkyl and alkaryl polyethylene glycol and polypropylene glycol ethers and thioethers); alkylphenoxypoly(ethyleneoxy)ethanols having alkyl groups containing from about 7 to about 18 carbon atoms and having from about 4 to about 240 ethyleneoxy units (e.g., heptylphenoxypoly(ethyleneoxy) ethanols and nonylphenoxypoly(ethyleneoxy) ethanols); polyoxyalkylene derivatives of hexitol including sorbitans, sorbides, mannitans, and mannides; partial long-chain fatty acids esters (e.g., polyoxyalkylene derivatives of sorbitan monolaurate, sorbitan monopalmitate, sorbitan monostearate, sorbitan tristearate, sorbitan monooleate, and sorbitan trioleate); condensates of ethylene oxide with a hydrophobic base (the base may be formed by condensing propylene oxide with propylene glycol); sulfur containing condensates (e.g., those prepared by condensing ethylene oxide with higher alkyl mercaptans, such as nonyl, dodecyl, or tetradecyl mercaptan, or with alkylthiophenols where the alkyl group contains from about 6 to about 15 carbon atoms); ethylene oxide derivatives of long-chain carboxylic acids (e.g., lauric, myristic, palmitic, or oleic acids or mixtures of acids, such as tall oil fatty acids); ethylene oxide derivatives of long-chain alcohols (e.g., octyl, decyl, lauryl, or cetyl alcohols); and ethylene oxide/propylene oxide copolymers.

Non-limiting examples of dispersants for use in the oil emulsion include sodium lignin sulfonate, calcium lignin sulfonate, ammonium lignin sulfonate, and lignin sulfonic acid, as well as any lignin based dispersant.

The polycarboxy acid based binder composition includes a polycarboxy polymer, a crosslinking agent, and optionally, a catalyst. A suitable polycarboxy polymer for use in the binder composition is an organic polymer or oligomer that contains more than one pendant carboxy group. The polycarboxy polymer may be a homopolymer or copolymer prepared from unsaturated carboxylic acids including, but not limited to, acrylic acid, methacrylic acid, crotonic acid, isocrotonic acid, maleic acid, cinnamic acid, 2-methylmaleic acid, itaconic acid, 2-methylitaconic acid, and α,β-methyleneglutaric acid. Alternatively, the polycarboxy polymer may be prepared from unsaturated anhydrides such as maleic anhydride, itaconic anhydride, acrylic anhydride, methacrylic anhydride, and mixtures thereof. Methods for polymerizing these acids and anhydrides are easily identified by one of ordinary skill in the art.

In addition, the polycarboxy polymer may include a copolymer of one or more of the unsaturated carboxylic acids or anhydrides described above and one or more vinyl compounds including, but not limited to, styrene, a-ethylstyrene, acrylonitrile, methacrylonitrile, methyl acrylate, ethyl acrylate, n-butyl acrylate, isobutyl acrylate, methyl methacrylate, n-butyl methacrylate, isobutyl methacrylate, glycidyl methacrylate, vinyl methyl ether, and vinyl acetate. Methods for preparing these copolymers would be easily identified by those ordinarily skilled in the art.

In one exemplary embodiment, the polycarboxy polymer is a low molecular weight polyacrylic acid, preferably having a molecular weight ranging from about 500-10,000, prepared by polymerizing an acrylic acid monomer in water in the presence of a cure accelerator that contains an alkali metal salt of a phosphorous-containing inorganic acid as described in U.S. Pat. No. 6,933,349 to Chen et al., which is incorporated herein by reference in its entirety. The polyacrylic acid may be phosphite-terminated. The cure accelerator used in this process may include sodium hypophosphite, sodium phosphate, potassium phosphate, disodium pyrophosphate, tetrasodium pyrophosphate, sodium tripolyphosphate, sodium hexamethaphosphate, potassium phosphate, potassium tripolyphosphate, sodium trimetaphosphate, sodium tetramethaphosphate, or mixtures thereof. The low molecular weight polyacrylic acid is subsequently reacted with a polyhydroxy crosslinking agent to form a binder composition. In the process disclosed by Chen et al., the molar ratio of hydroxyl groups in the polyhydroxy crosslinking agent to carboxylic acid groups in the polyacrylic acid may range from 0.4 to 0.6. It is to be noted that when the polycarboxy polymer is prepared in this manner, the polyacrylic acid can be crosslinked without the addition of a catalyst.

The binder composition utilized in the formation of the fibrous insulation product also includes a crosslinking agent. Crosslinking agents suitable for use in the binder composition include, but are not limited to, polyols that contain at least two hydroxyl groups, such as, for example, glycerol, trimethylolpropane, trimethylolethane, diethanolamine, triethanolamine, 1,2,4-butanetriol, ethylene glycol, glycerol, pentaerythritol, sorbitol, sucrose, glucose, resorcinol, catechol, pyrogallol, 1,3-propanediol, 1,4-butanediol, 1,6-hexanediol, 1,4-cyclohexane diol, 2-butene-1, erythritol, pentaerythritol, sorbitol, β-hydroxyalkylamides, trimethylol propane, glycolated ureas, and mixtures thereof. Preferably, the crosslinking agent is triethanolamine or glycerol.

Optionally, the binder composition includes a catalyst. The catalyst may include an alkali metal salt of a phosphorous-containing organic acid; in particular, alkali metal salts of phosphorus acid, hypophosphorus acid, or polyphosphoric acids. Examples of such phosphorus catalysts include, but are not limited to, sodium phosphite, potassium phosphite, disodium pyrophosphate, tetrasodium pyrophosphate, sodium tripolyphosphate, sodium hexametaphosphate, potassium phosphate, potassium polymetaphosphate, potassium polyphosphate, potassium tripolyphosphate, sodium trimetaphosphate, sodium tetrametaphosphate, and mixtures thereof. In addition, the catalyst may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, the catalyst may be a mixture of phosphorus and fluoroborate compounds. In exemplary embodiments, the catalysts include sodium hypophosphite, sodium phosphite, and mixtures thereof.

The presence of water, dust, and/or other microbial nutrients in the insulation product 10 may support the growth and proliferation of microbial organisms. Bacterial and/or mold growth in the insulation product may cause odor, discoloration, and deterioration of the insulation product 10, such as, for example, deterioration of the vapor barrier properties of the Kraft paper facing. To inhibit the growth of unwanted microorganisms such as bacteria, fungi, and/or mold in the insulation product 10, 100, the insulation pack 40 may be treated with one or more anti-microbial agents, fungicides, and/or biocides. The anti-microbial agents, fungicides, and/or biocides may be added during manufacture or in a post manufacture process of the insulation product 10.

The binder composition may optionally contain conventional additives such as pigments, dyes, colorants, oils, fillers, thermal stabilizers, emulsifiers, anti-foaming agents, anti-oxidants, organosilanes, colorants, and/or other conventional additives. Other additives may be added to the binder composition for the improvement of process and product performance. Such additives include coupling agents (e.g., silane, aminosilane, and the like), dust suppression agents, lubricants, wetting agents, surfactants, antistatic agents, and/or water repellent agents.

The glass fibers having the uncured resinous binder adhered thereto may be gathered and formed into an uncured pack 40 on the facer 12 on an endless forming conveyor 45 within the forming chamber 25 with the aid of a vacuum (not shown) drawn through the insulation pack 40 from below the forming conveyor 45. The facing material may be recycled paper, calendared paper, conventional Kraft paper, or some other facing material known to those of skill in the art. It is to be noted that throughout this application, the facers 12, 16 may be facing materials having thereon a pre-applied adhesive. Alternatively, an asphalt coating may be used both to adhere the insulation product to the Kraft paper facing and to provide vapor barrier properties to the paper. For instance, an asphalt layer may be applied in molten form and pressed against the fibrous insulation material before hardening to bond the Kraft facing material to the insulation material. As illustrated in FIG. 1, the facer 12 may be supplied to the conveyor 45 by roll 90. The residual heat from the glass fibers and the flow of air through the insulation pack 40 and facer 12 during the forming operation are generally sufficient to volatilize a majority of the water from the binder before the glass fibers exit the forming chamber 25, thereby leaving the remaining components of the binder on the fibers as a viscous or semi-viscous high-solids liquid.

The coated uncured pack 40, which is in a compressed state due to the flow of air through the pack 40 in the forming chamber 25, and the facer 12 are then transferred out of the forming chamber 25 under exit roller 50 to a transfer zone 55 where the insulation pack 40 vertically expands due to the resiliency of the glass fibers. The expanded uncured pack 40 and facer 12 are then heated, such as by conveying the pack 40 through a curing oven 60 where heated air is blown through the insulation pack 40 and facer 12 to evaporate any remaining water in the binder, cure the binder and the adhesive, rigidly bond the fibers together in the insulation pack 40, and adhere the facer 12 to the insulation pack 40. The facer 12 and the insulation pack 40 are heated to a temperature at or above the temperature of the adhesive for a time period sufficient to at least partially melt the adhesive and bond the adhesive to the insulation pack 40.

Specifically, heated air is forced though a fan 75 through the lower oven conveyor 70, the insulation pack 40, the upper oven conveyor 65, and out of the curing oven 60 through an exhaust apparatus 80. The cured binder imparts strength and resiliency to the faced insulation product 10. Also, in the curing oven 60, the pack 40 may be compressed by upper and lower foraminous oven conveyors 65, 70 to form a faced insulation product 10 having a predetermined thickness. It is to be appreciated that the drying and curing of the binder and the waterless, thin-film adhesive may be carried out in either one or two different steps. The distance between the lower flight of the belt 65 and the upper flight of the belt 70 determines the thickness of the fibrous pack 40. It is to be appreciated that although FIG. 1 depicts the conveyors 60, 70 as being in a substantially parallel orientation, they may alternatively be positioned at an angle relative to each other. The faced insulation product 10 is depicted generally in FIG. 1A.

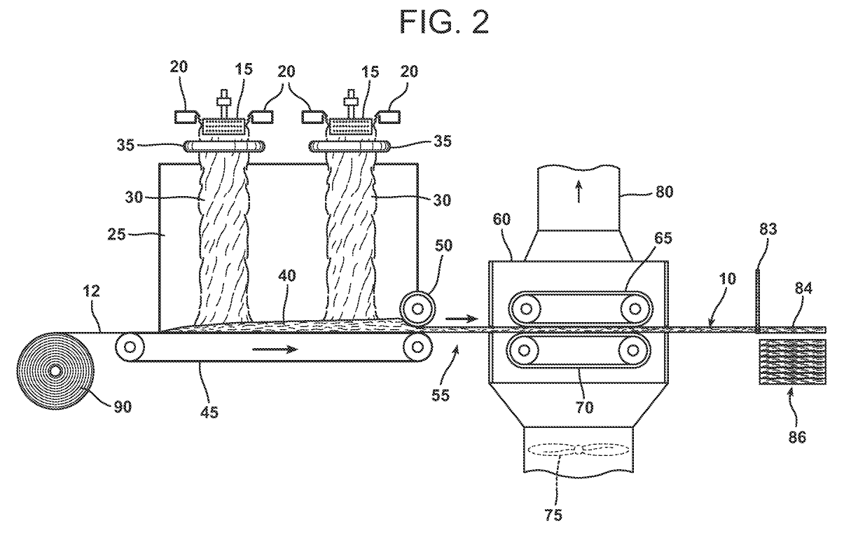

The faced fibrous insulation 10 then exits the curing oven 60 and may be rolled by roll-up device 82 for storage and/or shipment. The faced fibrous insulation product 10 may subsequently be unrolled and cut. As depicted in FIG. 2, the faced fibrous insulation product 10 may be cut to a predetermined length by a cutting device such as a blade or knife 83 to form panels 84 of the faced fibrous insulation. The panels 84 may be stacked or bagged by a packaging apparatus 86.

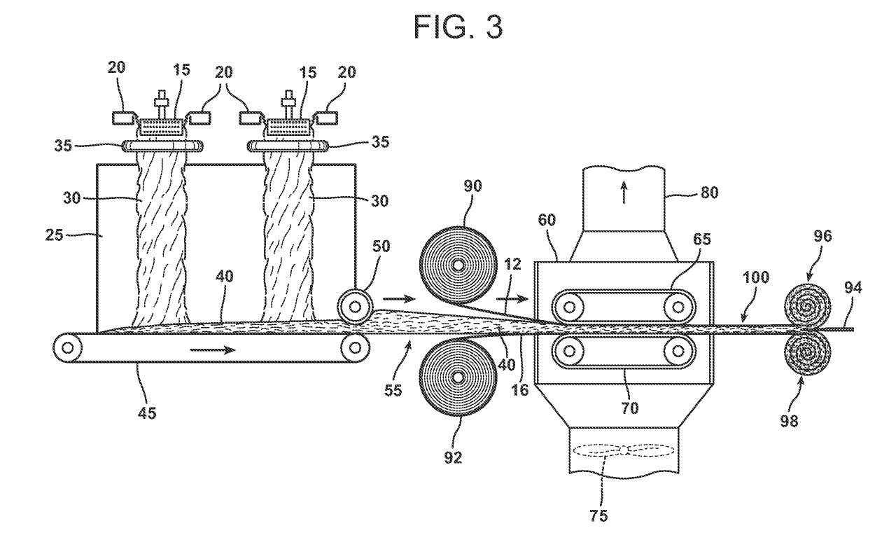

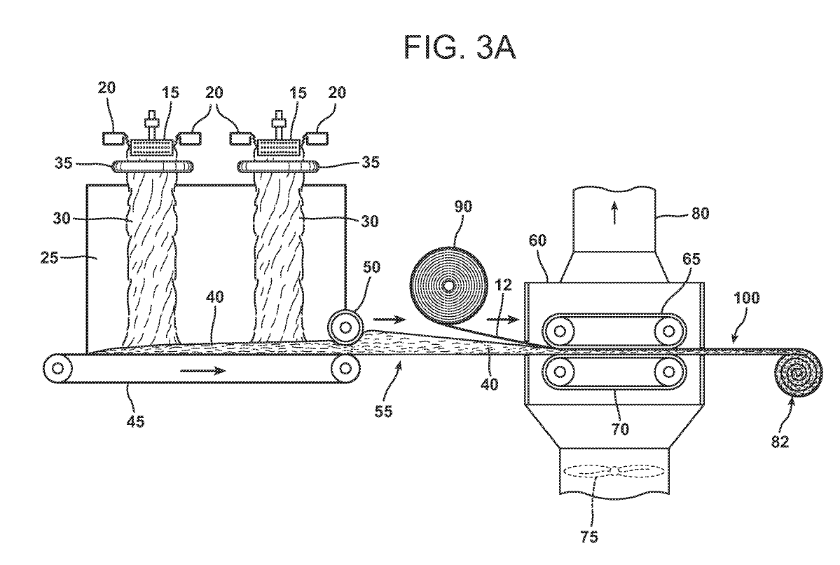

In an alternative embodiment, facing materials may be applied to both major surfaces of the fibrous insulation 14, as shown in FIG. 3. In one exemplary embodiment, facing materials 12, 16 are positioned on the top and bottom major surface of the uncured pack 40. It is to be appreciated that the facing materials 12, 16 may be the same or different. The facing materials 12, 16 are fed to the uncured pack 40 from rolls 90 and 92, respectively. The expanded uncured pack 40 and facers 12, 16 are then heated in a curing oven 60 where heated air is blown through the insulation pack 40 and facers 12, 16 and out of the curing oven 60 through an exhaust apparatus 80. Also, in the curing oven 60, the uncured pack 40 may be compressed by conveyors 65, 70 to form a double-faced fibrous insulation product 100 having a predetermined thickness. As the double-faced fibrous insulation product 100 exits the oven 60, it is bisected by a bisect saw 94 or other suitable cutting device and may be rolled into two rolls by an upper roll-up device 96 and a lower roll-up device 98. The products thus formed are insulation products 10, each having thereon a facer 12 on one major surface thereof, such as is depicted in FIG. 1A. It is to be understood that although FIG. 3 depicts the addition of two facing materials 12, 16, one facing material 12 could as easily positioned on one major surface of the insulation pack 40, such as from roll 90. In such an embodiment, there is no need to split the cured pack emerging from the oven 60. Such an embodiment is depicted generally as FIG. 3A.

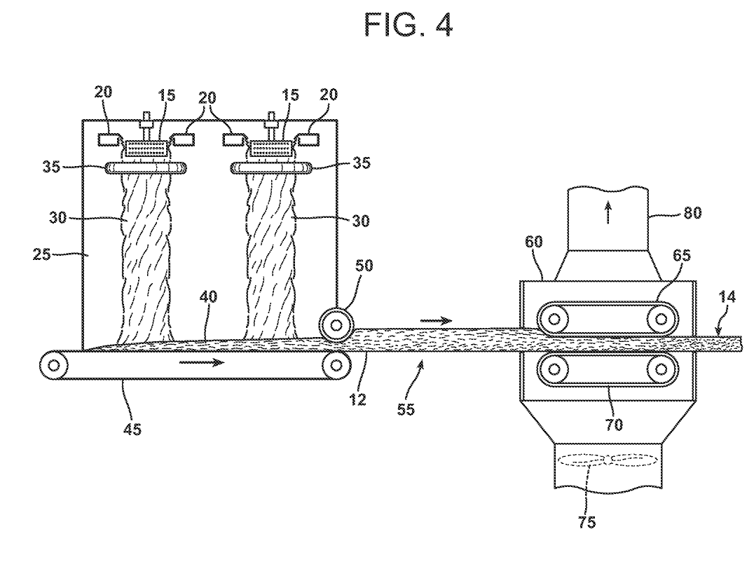

It is to be appreciated that an insulation product according to the present invention may not contain a facer 12, such as is depicted in FIG. 4. Similar to the embodiment discussed above with respect to FIG. 1, the uncured pack 40, but without the facer 12, is heated in the oven 60 to remove water from the binder, cure the binder, and bond the fibers together. The insulation product 14 that emerges may then be rolled (not shown) for shipping or storage or cut to a predetermined length (not shown).

In one or more exemplary embodiment, the insulation product is used as thermal insulation in residential dwellings. There are numerous advantages provided by the inventive insulation product. For instance, the insulation product is unexpectedly soft to the touch and possesses a reduced occurrence of loose glass fibers. As a result, potential irritation to workers handling and/or installing the fibrous insulation product is substantially reduced. In addition, the fibrous insulation product may have a high recycled glass content, which provides for a more environmentally friendly product.

Having generally described this invention, a further understanding can be obtained by reference to certain specific examples illustrated below which are provided for purposes of illustration only and are not intended to be all inclusive or limiting unless otherwise specified.

### Example

Forty random individuals (13 female and 27 male) from within Owens Corning (Granville, Ohio) volunteered to participate an internal focus group to determine the relative “softness” of the inventive insulation product compared to three conventional insulation products and cotton. The softness evaluation was conducted by two different methods. First, a paired comparison was conducted in which each individual was presented with two 4″×6″ samples. The samples were contained within a cardboard box so that the samples could not be seen by the participant. Samples A-C were samples of commercial fiberglass insulation products. The participants were then asked to select which of the two samples was “softer”. This evaluation was conducted ten times so that each possible combination of the five samples could be compared. Because the participants were unable to see the color or appearance of the fibers, there was no obvious bias to these factors. If no discernable difference was detected, the participants were not forced to pick one sample over the other. The results are set forth in Table 1.

TABLE 1

| | Inventive | Inventive Insulation | |
|---|---|---|---|
| | Insulation | “Preferred” or | Ratio of “for” to |
| | Preferred (%) | “Equal To” (%) | “against” |
| Sample A | 90 | 95 | 18:1 |
| Sample B | 80 | 90 | 8:1 |
| Sample C | 63 | 93 | 8:1 |
| Cotton Batting | 3 | 33 | 1:24 |

As shown in Table 1, the inventive insulation product was clearly differentiated from and was superior in softness compared to standard residential commercial fiberglass insulation batts.

In a second evaluation, each of the samples was presented to the participants and the participants were asked to rate the samples on a scale of 1 to 10. “10” was defined as “cottony soft” and “1” was defined as harsh or “brashy”. As with the first evaluation, the participants were unable to see the samples. As a matter of protocol, the samples that were used were changed after each participant to avoid any anomalies within a given sample that may potentially cause a bias. Additionally, the order in which the samples were evaluated was varied. The average ratings of the participants are set forth in Table 2.

TABLE 2

| | Overall | Male | Female |
|---|---|---|---|
| Sample A | 3.5 | 3.8 | 2.9 |
| Sample B | 4.5 | 4.9 | 3.6 |
| Sample C | 4.8 | 5.3 | 3.6 |
| Cotton Batting | 8.6 | 8.7 | 8.3 |
| Inventive Insulation Product | 7.1 | 7.2 | 6.8 |

As can be discerned from Table 2, there was a clear line of demarcation between the cotton batting and the inventive insulation product and the comparative commercial insulation products of Samples A-C. It was also noted that there were differences between the male and female participants. In particular, it appeared that females were more discriminating between the inventive insulation product and the three conventional insulation products then the male participants.

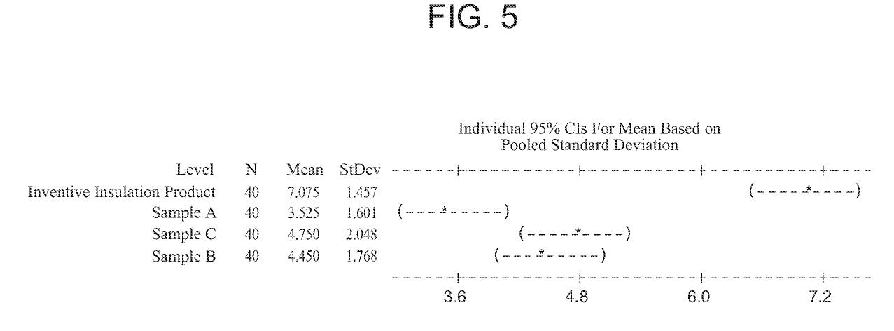

In addition, it was determined that the inventive insulation product was statistically significantly different than the conventional insulation products of Samples A-C. The results of a standard deviation analysis are set forth below in Tables 3, 4, and FIG. 5.

TABLE 3
One-way ANOVA: C6 vs. C7

| Source | DF | SS | MS | F | P |
|---|---|---|---|---|---|
| C7 | 3 | 273.45 | 91.5 | 30.37 | 0.000 |
| Error | 156 | 468.15 | 3.0 | | |
| Total | 159 | 741.60 | | | |

S = 1.732
R-Sq = 36.87%
R-Sq(adj) = 35.66%

TABLE 4

| Level | N | Mean | Standard Deviation |
|---|---|---|---|
| Inventive Insulation Product | 40 | 7.075 | 1.547 |
| Sample A | 40 | 3.525 | 1.601 |
| Sample C | 40 | 4.750 | 2.048 |
| Sample B | 40 | 4.450 | 1.768 |

Pooled Standard Deviation = 1.732

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A soft fibrous insulation product comprising:
a plurality of randomly oriented fibers having an average fiber diameter less than about 5.5 microns;
an oil, said oil being present in an amount greater than about 0.5% by weight of said fibrous insulation product; and
a binder applied to at least a portion of said fibers and interconnecting said fibers.

2. The soft fibrous insulation product of claim 1, wherein said oil is present as an emulsion containing at least one member selected from one or more surfactant and one or more dispersant.

3. The soft fibrous insulation product of claim 1, wherein said plurality of fibers includes recycled glass in an amount up to about 85% by weight of said insulation product.

4. The soft fibrous insulation product of claim 1, wherein said average fiber diameter is from about 2.5 microns to about 5.5 microns.

5. The soft fibrous insulation product of claim 1, wherein said oil is selected from mineral oils, synthetic oils, silicone oils, plant oils and mixtures thereof.

6. The soft fibrous insulation product of claim 5, wherein said binder is selected from a polyacrylic acid glycerol binder, a polyacrylic acid triethanolamine binder, a phenol-formaldehyde binder, a urea-formaldehyde binder, a bio-based binder, a carbohydrate-based binder, a protein-based binder, a vegetable oil-based binder, a plant oil-based binder, a urethane-based binder, a furan-based binder and combinations thereof.

7. The soft fibrous insulation product of claim 6, wherein said binder is a polyacrylic acid-based binder.

8. The soft fibrous insulation product of claim 1, wherein said binder, said average fiber diameter, and said oil have a synergistic effect which causes said fibrous insulation product to be softer to the touch than conventional insulation products.

9. A soft glass fiber for forming a fibrous insulation product comprising:
a glass fiber having a fiber diameter less than about 5.5 microns, and
a binder on at least a portion of said glass fiber, said binder including an oil selected from mineral oils, synthetic oils, silicone oils, plant oils and mixtures thereof.

10. The soft glass fiber of claim 9, wherein said binder is selected from a polyacrylic acid glycerol binder, a polyacrylic acid triethanolamine binder, a phenol-formaldehyde binder, a urea-formaldehyde binder, a bio-based binder, a carbohydrate-based binder, a protein-based binder, a vegetable oil-based binder, a plant oil-based binder, a urethane-based binder, a furan-based binder and combinations thereof.

11. The soft glass fiber of claim 10, wherein said binder is a polyacrylic acid-based binder.

12. The soft glass fiber of claim 9, wherein said fiber diameter falls in the range from about 2.5 microns to about 5.5 microns.

13. The soft glass fiber of claim 10, wherein said oil is in the form of an emulsion containing at least one member selected from one or more surfactant and one or more dispersant.

14. A method of manufacturing a soft fiberglass insulation product comprising:
fiberizing molten glass to form individual glass fibers having an average fiber diameter less than about 5.5 microns;
applying a binder to at least a portion of said glass fibers,
applying an oil to at least a portion of said glass fibers in an amount greater than about 0.5% by weight of said fiberglass insulation product;
collecting said binder/oil coated glass fibers on a conveying apparatus to form a fibrous pack; and
heating said fibrous pack to dry said glass fibers and at least partially cure said binder and form said soft fiberglass insulation product.

15. The method of claim 14, further comprising:
adding said oil to said binder in an amount from about 1.0 to about 5.0% by weight of the insulation product.

16. The method of claim 14, wherein said glass fibers have an average fiber diameter from about 2.5 to about 5.0 microns.

17. The method of claim 16, wherein said binder is a polyacrylic acid-based binder.

18. The method of claim 14, wherein said glass fibers include recycled glass in an amount up to about 85% by weight of said insulation product.

19. The method of claim 16, wherein said oil is in the form of an emulsion containing at least one member selected from one or more surfactant and one or more dispersant.

20. The method of claim 14, wherein said binder, said average fiber diameter, and said oil have a synergistic effect which causes said fibrous insulation product to be softer to the touch than conventional insulation products.
